(19) United States
(12) Patent Application Publication
(10) Pub. No.: US 2012/0307847 A1
(43) Pub. Date: Dec. 6, 2012

(54) LASER APPARATUS

(75) Inventors: Shinobu TAMAOKI, Yokohama-shi (JP); Motoki KAKUI, Yokohama-shi (JP)

(73) Assignee: SUMITOMO ELECTRIC INDUSTRIES, LTD., Osaka-shi (JP)

(21) Appl. No.: 13/485,551

(22) Filed: May 31, 2012

Related U.S. Application Data
(60) Provisional application No. 61/493,254, filed on Jun. 3, 2011.

(30) Foreign Application Priority Data
Jun. 3, 2011 (JP) 2011-125229

(51) Int. Cl. H01S 3/067; H01S 3/10

(52) U.S. Cl. 372/6; 372/25

(57) ABSTRACT

The present invention relates to a laser apparatus having a structure for easily shortening a pulse. In the laser apparatus, as a result of a phase control unit adjusting a modulation period of an external modulator and an output period of pulsed light of a seed light source, it is possible to generate pulsed light which is outputted only during a period when the modulation period and the output period overlap each other.

### CROSS-REFERENCE TO RELATED APPLICATION

This application is based upon and claims the benefit of priorities from U.S. Provisional Application No. 61/493254, filed on Jun. 3, 2011 and Japanese Patent Application No. 2011-125229, filed on Jun. 3, 2011, the entire contents of which are incorporated herein by reference.

### BACKGROUND OF THE INVENTION

1. Field of the Invention

The present invention relates to a laser apparatus.

2. Related Background Art

Today, processing technology using lasers is attracting attention, and demands for high-power lasers are increasing in various fields including the processing field and medical field. In particular, fiber lasers containing an optical fiber doped with rare earth elements such as Yb and which adopts an amplification using pumping light or resonator structure based on pumping light is attracting attention since it is easy to handle and does not require a large-scale cooling facility since the thermal radiation is favorable. As one such fiber laser, known is MOPA (Master Oscillator Power Amplifier) which achieves high power by pulsing the light outputted from a light source by direct modulation or external modulation, and additionally amplifying the obtained pulsed light.

### SUMMARY OF THE INVENTION

The present inventors have examined the above prior art, and as a result, have discovered the following problems. That is, today, various methods for shortening the pulse of the pulsed light outputted from a laser apparatus are being examined and, for instance, in the case of a MOPA-type laser apparatus, there is a method of providing an oscillator unit, and shortening the pulse of the light to be amplified of the pulse operation and amplifying the same. Nevertheless, with this configuration, while the pulse peak will increase during the amplification process, there is a possibility that the pulse peak power will deteriorate due to the significant influence of the non-linear phenomena (stimulated Raman scattering (SRS), stimulated Brillouin scattering (SBS) and the like) of the medium to deliver the laser beam. Moreover, as a result of shortening the pulse, the input power to the amplifying medium will decrease, and this will lead to the increase in the number of optical components and costs such as for eliminating the ASE light that is generated during the amplification process. Moreover, in addition to the above, considered are a method of creating the finally output laser beam by subjecting such laser beam to pulse compression, and a method of mounting a modulator (acousto-optical modulator or the like) on the finally output laser beam to stop the laser beam, but all of these methods entail the complication and increased costs of the device, and are not able to easily achieve the pulse-shortening of the laser apparatus.

The present invention has been developed to eliminate the problems described above. It is an object of the present invention to provide a laser apparatus having a structure for easily shortening a pulse.

In order to achieve the foregoing object, the laser apparatus according to the present invention includes, as a first aspect, a light source, an optical modulator, a control unit, and a final amplifier. In the first aspect, the light source outputs pulsed light during a predetermined output period. The optical modulator outputs the pulsed light inputted from the light source thereto during a predetermined modulation period. The control unit controls a pulse width of the pulsed light outputted from the optical modulator, by adjusting the output period of the light source and the modulation period of the optical modulator. The final amplifier amplifies light outputted from the optical modulator.

In accordance with the laser apparatus according to the first aspect, as a result of causing the pulsed light outputted from the light source to pass through the optical modulator which outputs the pulsed light during a predetermined modulation period, the pulsed light is outputted during a period when the output period of the pulsed light and the modulation period of the optical modulator overlap each other, and it is thereby possible to generate pulse-shortened pulsed light. In addition, according to the foregoing configuration, since the pulse width can be easily controlled, short pulse generation can be easily achieved.

The laser apparatus according to the present invention may further comprise, as a second aspect applicable to the first aspect, an intermediate amplifier provided between the light source and the optical modulator. In the second aspect, the intermediate amplifier can amplify the pulsed light outputted from the light source, and output the amplified pulsed light toward the optical modulator so that the amplified pulsed light is inputted to the optical modulator.

Moreover, as a third aspect applicable to at least one of the first and second aspects, the intermediate amplifier may be configured from a plurality of amplifiers.

The laser apparatus according to the present invention may further include, as a fourth aspect applicable to at least one of the first to third aspects, an intermediate amplifier provided between the optical modulator and the final amplifier. In the fourth aspect, the intermediate amplifier may amplify the pulsed light outputted from the optical modulator, and output the amplified pulsed light toward the final amplifier so that the amplified pulsed light is inputted to the final amplifier.

In order to effectively achieve the foregoing operation, as a fifth aspect applicable to at least one of the first to fourth aspects, the control unit may change the pulse width of the pulsed light outputted from the optical modulator, by adjusting a period when the output period of the light source and the modulation period of the optical modulator overlap each other.

As a sixth aspect applicable to at least one of the first to fifth aspects, preferably, the final amplifier includes an amplification optical fiber, and a pumping light source for supplying pumping light to the amplification optical fiber. In addition, as this sixth aspect, the laser apparatus may further include a current control unit for controlling a current to be supplied to the pumping light source based on the pulse width of the pulsed light controlled by the control unit. According to the sixth aspect, as a result of controlling the current value in the final amplifier, it is possible to prevent the generation of unwanted light such as the increase of ASE, and thereby increase the safety.

Moreover, as a seventh aspect applicable to at least one of the first to sixth aspects, the positional relationship of the output period of the light source and the modulation period of the optical modulator on a common time axis may be set so that a part of the output period and a part of the modulation period overlap each other, and the output period is delayed from the modulation period. In accordance with the seventh aspect, as a result of providing the modulation period in front of the output period, it is possible to eliminate the response delay component of the pulse appearing in the subsequent stage of the output period of the light outputted from the light source.

### BRIEF DESCRIPTION OF THE DRAWINGS

FIG. 1 is a view showing the schematic configuration of a conventional laser apparatus;

FIGS. 2A and 2B are views for explaining the voltage modified by the modulator and the pulse waveform;

FIG. 3 is a view for explaining the intensity of the pulsed light outputted from the exit end;

FIG. 4 is a view showing the schematic configuration of an embodiment of the laser apparatus according to the present invention;

FIG. 5 is a view explaining the control method of the pulse width in the laser apparatus according to the present invention;

FIG. 6 is a view showing the schematic configuration of the laser apparatus according to the first modified example of the embodiment;

FIG. 7 is a view showing the schematic configuration of the laser apparatus according to the second modified example of the present embodiment;

FIG. 8 is a view showing the schematic configuration of the laser apparatus according to the third modified example of the present embodiment;

FIG. 9 is a view for explaining another example of the control method of the pulse width in the laser apparatus according to the present invention; and

FIG. 10 is a view showing the schematic configuration of the laser apparatus according to the fourth modified example of the present embodiment.

### DESCRIPTION OF THE PREFERRED EMBODIMENTS

In the following, embodiments for carrying out the present invention will be explained in detail with reference to the appended drawings. Note that the same reference numeral is given to the same element in the explanation of the drawings, and the redundant explanation thereof is omitted. In the ensuing explanation, a conventional laser apparatus is foremost explained, and the configuration of the laser apparatus according to this embodiment is subsequently explained.

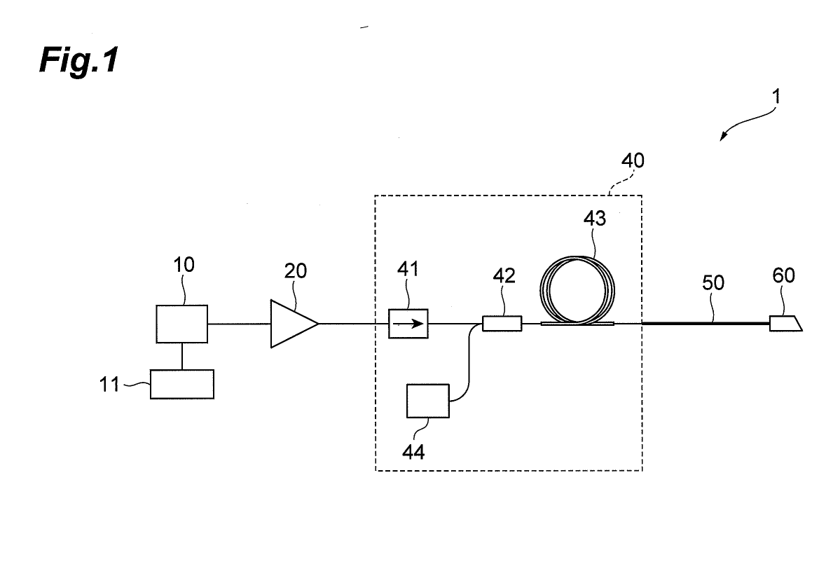

FIG. 1 is a view showing the schematic configuration of a conventional laser apparatus. The laser apparatus 1 shown in FIG. 1 is a MOPA (Master Oscillator Power Amplifier)-type fiber laser, and comprises a seed light source 10, a pulse generator 11, an intermediate amplifier 20 and a final amplifier 40. The seed light source 10 preferably includes a laser diode. The pulse generator 11 modulates the seed light source 10 by direct modulation or external modulation. Consequently, light outputted from the seed light source 10 becomes pulsed light. In other words, the seed light source 10 and the pulse generator 11 function as a light source which outputs light during a predetermined output period. The intermediate amplifier 20 amplifies the light outputted from the seed light source 10. The final amplifier additionally amplifies the light that was amplified by the intermediate amplifier 20. In other words, with this laser apparatus 1, the pulsed light modulated by the pulse generator 11 and outputted from the seed light source 10 is sequentially amplified by the intermediate amplifier 20 and the final amplifier 40. Subsequently, the amplified pulse is outputted through an exit end 60 upon passing through a delivery fiber 50 disposed in a stage that is subsequent to the final amplifier 40.

The pulse generator 11 is a device for modulating the seed light source 10, and includes a function for manually controlling the start/end of the pulse operation, and a function for controlling the start/end of the pulse operation by using an external control signal or the like. Generally speaking, the device that sends control signals to the pulse generator 11 is often a device that is different from the laser apparatus 1 such as a processing unit or a PC.

The final amplifier 40 comprises an optical isolator 41, an optical combiner 42, an amplification optical fiber 43, and a pumping light source 44.

The optical isolator 41 allows the light outputted from the intermediate amplifier 20 to pass through the optical combiner 42, but does not allow the light to pass through in the opposite direction. The optical combiner 42 inputs the light to be amplified which arrived from the optical isolator 41 and the pumping light which arrived from the pumping light source 45, and combines the light to be amplified and pumping light. The combined light is outputted from the optical combiner 42 to the amplification optical fiber 43.

The amplification optical fiber 43 amplifies the light to be amplified by wave-guiding the light to be amplified and the pumping light which arrived from the optical combiner 42. Subsequently, the amplified light is outputted to the delivery optical fiber 50 disposed in a stage that is subsequent to the final amplifier 40. The delivery optical fiber 50 wave-guides the light which arrived from the amplification optical fiber 43 from one end to the other end, and such light is outputted to the outside of the laser apparatus 1 from the exit end 60 connected to the other end.

The amplification optical fiber 43 is an optical fiber having a double cladding structure, and is doped with rare earth elements (for instance, Yb, Er, Nd, Tm, Ho, Tb and the like), and includes a core region through which the light to be amplified propagates, an inner cladding region which surrounds the core region and through which the pumping light propagates, and an outer cladding region which surrounds the inner cladding region. Moreover, absorption of the pumping light in the amplification optical fiber 43 is decided by the characteristics of the amplification fiber 43, and the absorption mainly changes by adjusting the MFD of the core, the diameter of the inner cladding region, and the additive concentration of rare earths of the core region. For example, with a Yb-doped fiber having an additive concentration of approximately 10000 ppm, MFD of approximately 7 μm, an inner cladding region diameter of approximately 130 μm, and a length of 5 m, pumping light of approximately 2.4 dB is absorbed in a pumping wavelength of a 915 nm band (915±20 nm). Note that with this fiber absorption example, the pumping wavelength of a 915 nm band was used for amplifying the Yb-doped fiber, but a 940 nm band (940±5 nm) or a 976 nm band (976±5 nm) may also be used.

Moreover, the delivery optical fiber 50 is an optical fiber of a single cladding structure having a core diameter and NA that are equivalent to the amplification optical fiber 45 and the optical fiber 43.

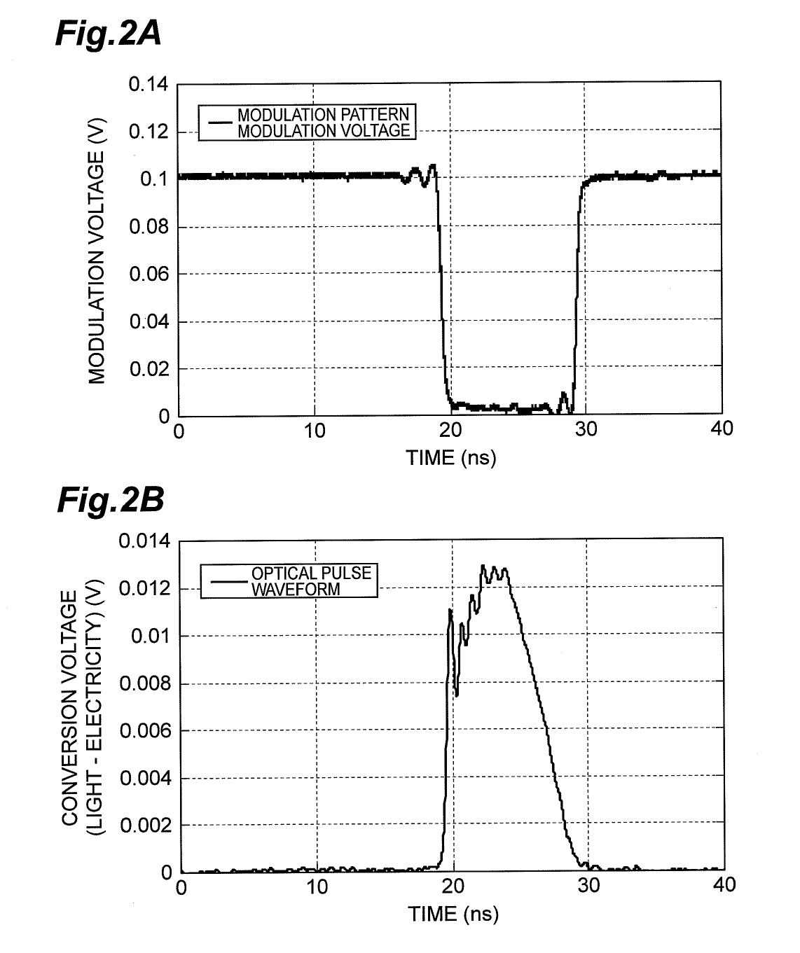

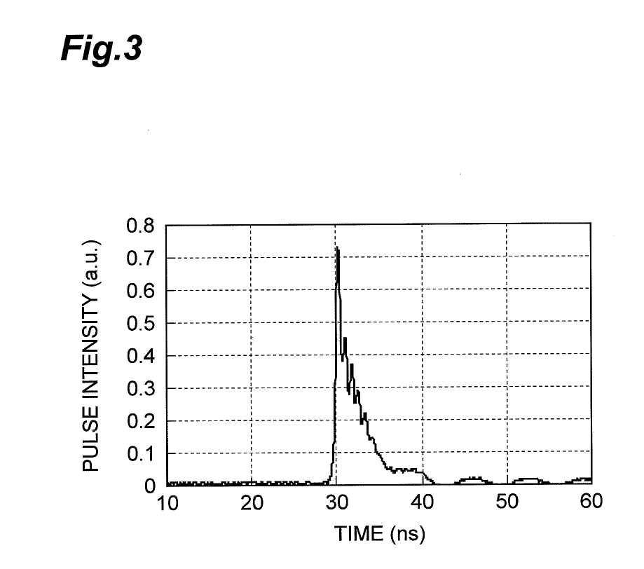

The shape of the pulsed light outputted from the laser apparatus 1 having the foregoing configuration is now explained with reference to FIGS. 2A, 2B and 3. Foremost, the pulsing of light outputted from the seed light source 10 by the pulse generator 11 is shown in FIGS. 2A and 2B. Note that, in FIG. 2A, the modulation voltage is a voltage that is generated by the pulse generator 11 (may be either the direct modulation method or the external modulation method), and refers to the voltage for pulsing the light from the seed light source 10. Moreover, FIG. 2A shows the modulation voltage from the pulse generator 11, and FIG. 2B shows the optical pulse waveform generated by the modulation voltage based on the pulse generator 11. Note that, as shown in FIGS. 2A and 2B, the waveforms of the modulation voltage of the pulse generator 11 and the pulsed light outputted from the light source become different shapes due to the influence of the seed light source or due to the dependency on the time constant around the electrical substrate in the pulse generator 11. In FIG. 2A, the half-value width of the pulse of the modulation voltage is 10 ns, and the repetition frequency is 100 kHz. In FIG. 2B, the half-value width of the pulse of the optical waveform of the light to be amplified is approximately 6 ns.

FIG. 3 shows the shape of the pulsed light outputted from the exit end 60 of the laser apparatus 1; that is, the shape of the amplified pulsed light. The pulsing conditions are the same as the conditions of FIGS. 2A and 2B. As shown in FIG. 3, the half-value width of the pulse of the amplified pulsed light is shorter, and is approximately 1 ns. The pulse peak power and the half-value width of the pulse are dependent on the repetition frequency, and in this case the conditions are the same as the conditions of FIGS. 2A and 2B. Accordingly, with the convention laser apparatus 1, the pulse width of the laser beam of the final output unit is decided based on the pulse width that is decided by the pulse generator 11. Thus, as the methods of further shortening the pulse width obtained in FIG. 3, the following three methods were mainly adopted.

As the first method, there is a method of providing an oscillator unit for further shortening the pulse width of the pulsed light outputted from the light source, and amplifying and outputting the additionally pulse-shortened light. Nevertheless, this first method is susceptible to the significant influence of the non-linear phenomena (stimulated Raman scattering (SRS), stimulated Brillouin scattering (SBS) and the like) of the medium to propagate the laser beam, and the pulse peak powder of the amplified pulsed light tends to deteriorate. Moreover, as a result of shortening the pulse width, the power of the light to be inputted to the amplification medium is low. Consequently, it becomes necessary to eliminate the ASE light that is generated during the amplification, and this will affect the number of components or costs.

As the second method, there is a method of subjecting the laser beam outputted from the final amplifier to pulse compression. Nevertheless, this second method entails the problem of increased costs.

In addition, as the third method, there is a method of modulating the laser beam outputted from the final amplifier with a modulator such as an acousto-optical modulator (AOM) or the like and thereby stopping the laser beam. Nevertheless, with this third method, since the power required for the laser beam cutting is large, the conversion efficiency of electricity/optical energy is inferior. Moreover, since strong laser apparatus light is inputted to the AOM itself, highly durable elements are required, and there is a problem in that the device becomes costly.

Meanwhile, the laser apparatus according to this embodiment is configured to adjust the pulse width and output pulse-shortened light by newly providing an external modulator in a stage that is before the final amplifier.

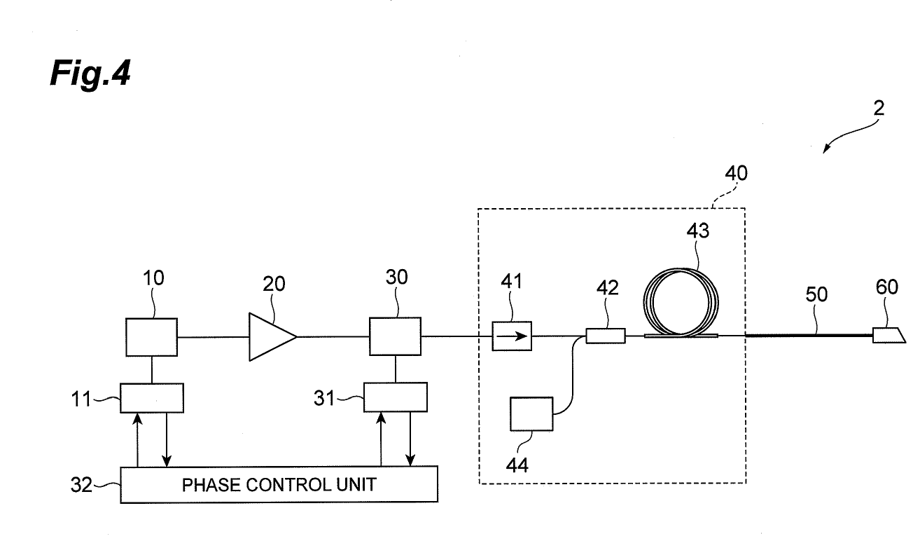

FIG. 4 shows the configuration of the laser apparatus 2 according to the present embodiment. The laser apparatus 2 shown in FIG. 4 differs from the conventional laser apparatus 1 shown in FIG. 1 with respect to the following points. In other words, an external modulator 30 for modulating the intensity of the input light is provided in a stage that is subsequent to the intermediate amplifier 20 and in a stage that is before the final amplifier 40, and a pulse generator 31 which connects to the external modulator 30 is provided for instructing the predetermined modulation period for the external modulator 30 to output light. Additionally provided is a phase control unit 32 for adjusting the output period of the pulse generator 11 connected to the seed light source 10, and adjusting the modulation period of the pulse generator 31 connected to the external modulator 30. Here, the temporal relationship of the output period and the modulation period is referred to as a “phase”. Note that, with respect to the method of controlling the phase, the “synchronization” function that is normally equipped as a function of the pulse generator also has the same function as the operations that are performed by the phase control unit 32. In other words, in substitute for the phase control by the phase control unit 32, the “synchronization” function provided to the pulse generator 31 may also be used.

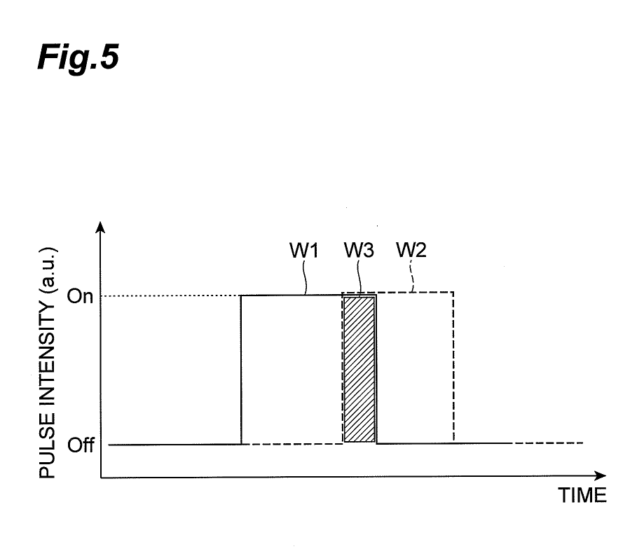

Here, the method of generating pulsed light with a short pulse width based on the laser apparatus 2 is now explained with reference to FIG. 5. FIG. 5 is a view for explaining the control method of the width of the pulsed light by the laser apparatus 2. In FIG. 5, the waveform for specifying the output period for outputting the pulsed light from the seed light source 10 contained in the laser apparatus 2 is represented as W1, the waveform for specifying the modulation period for outputting light from the external modulator 30 is represented as W2, and the pattern of the pulsed light outputted from the exit end 60 is represented as W3. Here, light is outputted during the period in which the optical pulse waveform intensity is ON, and light is not outputted during the period in which the optical pulse waveform intensity is OFF. Note that the waveform of the pulsed light outputted from the seed light source 10 also has a pulse width of 10 ns as with FIGS. 2A and 2B. Meanwhile, the width of the ON period (modulation period) of the external modulator 30 is preferably narrower, but also may be broader, than the width of the pulsed light (predetermined period) outputted from the seed light source 10. Moreover, with the optical modulation by the external modulator 30, desirably, the rise and fall response time is fast.

As shown in FIG. 5, with the laser apparatus 2 according to this embodiment, the pulsed light that is outputted only during a predetermined output period as shown with the pulse waveform W1 is outputted from the seed light source 10. In addition, the pulsed light that was amplified by the intermediate amplifier 20 is inputted to the external modulator 30, and is output-controlled so that it is outputted from the external modulator 30 only during the predetermined modulation period as shown with the waveform W2. Here, since the output period and the modulation period overlap each other on a common time axis as shown in FIG. 5, only a portion where the both periods overlap each other (W3 in FIG. 5) is cut out. This cut portion becomes the pulsed light, and the cut pulsed light is amplified by the final amplifier 40 and thereafter outputted through the exit end 60.

Thus, according to the laser apparatus 2, as a result of controlling the modulation period of the external modulator 30 and the output period of pulsed light of the seed light source 10 by the phase control unit 32, it is possible to cut out a pulse waveform of an arbitrary pulse width. Consequently, not only it is possible to shorten the pulse width, the pulse width can be varied with a simple device. Moreover, since there is no need to control the intensity and the like of the pulsed light outputted from the seed light source 10, the intensity of light that is inputted to the intermediate amplifier 20 and the final amplifier 40 can be stabilized. Note that the phase control by the phase control unit 32 is preferably set individually for each decide since such phase control is dependent on the propagation time of the laser beam in the seed light source 10 and the intermediate amplifier 20.

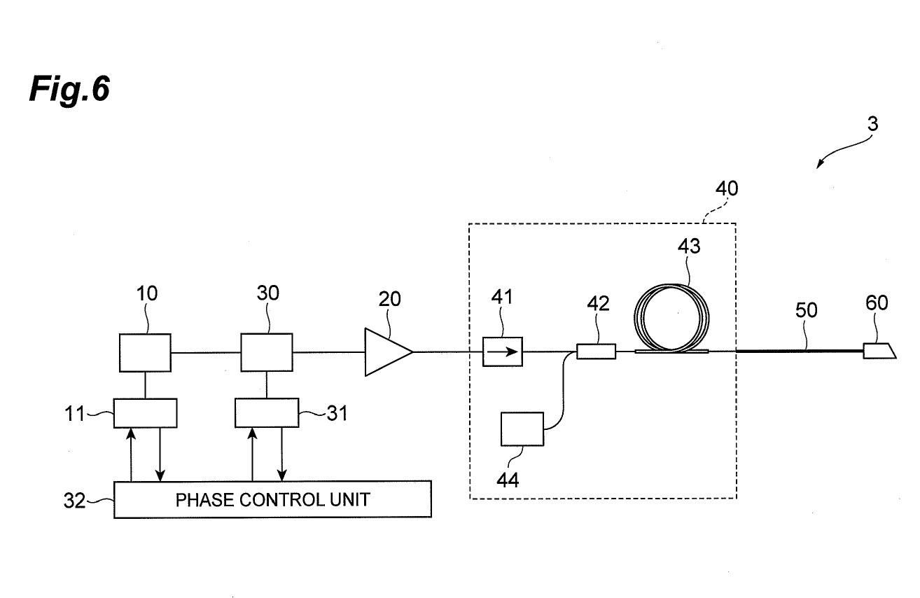

A modified example of the laser apparatus according to the foregoing embodiment is now explained. FIG. 6 is a view showing the schematic configuration of the laser apparatus 3 according to the first modified example of the present embodiment. The laser apparatus 3 of FIG. 6 differs from the laser apparatus 2 with respect to the position of the intermediate amplifier 20. In other words, as shown with the laser apparatus 3, the intermediate amplifier 20 may also be positioned in a stage that is subsequent to the external modulator 30.

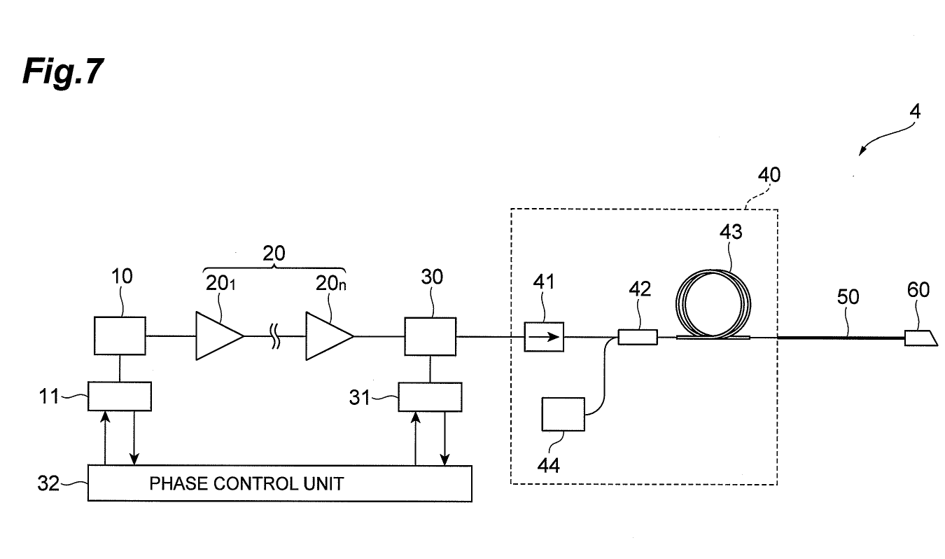

Moreover, FIG. 7 is a view showing the schematic configuration of the laser apparatus 4 according to a second modified example of the present embodiment. The laser apparatus 4 of FIG. 7 has n-number (201 to 20n) of intermediate amplifiers in comparison to the laser apparatus 2. Accordingly, the number of intermediate amplifiers 20 is variable. Note that the intermediate amplifier 20 is not an essential constituent element, and the intermediate amplifier 20 may be omitted from the configuration.

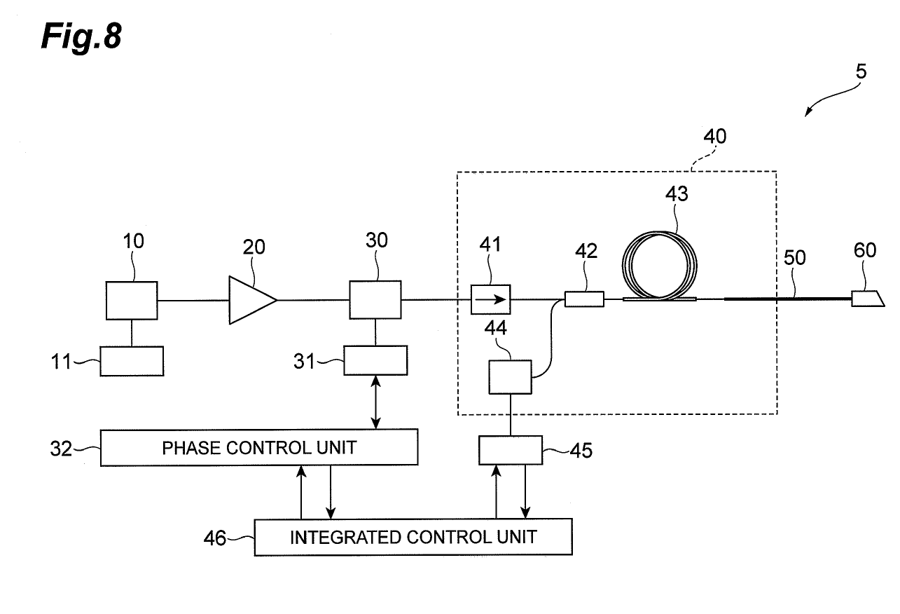

FIG. 8 is a view showing the schematic configuration of the laser apparatus 5 according to a third modified example of the present embodiment. The laser apparatus 5 of FIG. 8 differs from the laser apparatus 2 with respect to the point that the laser apparatus 5 comprises a current control unit 45 for controlling the current to be supplied to the pumping light source 44, and an integrated control unit 46 to be connected to the phase control unit 32 and the current control unit 45. The current control unit 45 and the integrated control unit 46 are provided for increasing the safety upon pulse-shortening the laser beam in the laser apparatus 5. Specifically, when the laser beam is pulse-shortened, the intensity of the pulsed light decreases according to the pulse width. Accordingly, in terms of practical application, the pulse light needs to be sufficiently amplified in the subsequent amplifier. Nevertheless, there are cases where unwanted light is generated, such as the increase of ASE, during amplification, and the safety of the amplifier itself is impaired. Thus, as with the laser apparatus 5, it is desirable to control the intensity of the output light by limiting the current that is supplied to the pumping light source 44 of the final amplifier 40. Specifically, with the laser apparatus 5, the integrated control unit 46 acquires information pertaining to the pulse-shortening of the laser beam received from the phase control unit 32, and the control unit 46 instructs the current control unit 45 of the current value of the current to be supplied to the pumping light source 44. It is thereby possible to increase the safety of the final amplifier upon shortening the pulse.

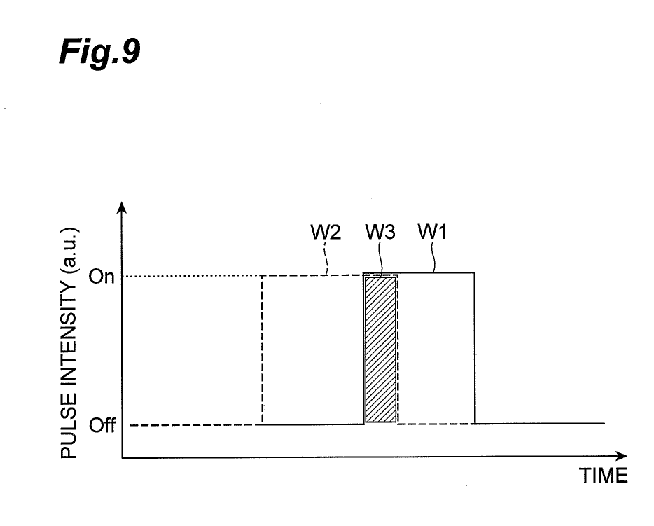

Moreover, with the laser apparatus 2 according to the foregoing embodiment, as shown in FIG. 4, a case was explained where the output period in the waveform W1 of the pulsed light outputted from the seed light source 10 is temporally positioned in front of the modulation period in the waveform W2 by the external modulator 30. However, as shown in FIG. 9, the modulation period and the output period may be temporally opposite. In other words, even in cases where the modulation period in the waveform W2 of the external modulator 30 is temporally set later than the output period in the wavelength W1 of the pulsed light outputted from the seed light source 10, pulsed light is outputted from the exit end 60 so long as there is a location where the ON periods overlap each other, such as the period shown as W3 in FIG. 9. Accordingly, the pulse-shortening of the laser beam can be realized. In particular, as shown in FIG. 9, when the modulation period of the external modulator 30 is temporally set in front relative to the output period, the response delay components contained in the pulsed light that was amplified by the intermediate amplifier 20 can be effectively removed by being cut out by the external modulator 30. In other words, as a result of controlling the pulse generator 11 and the pulse generator 31 so as to achieve the pulse waveform as shown in FIG. 9, the unwanted delay components of the pulse can be reduced, and the thermal influence on the work piece from the laser processing can be reduced.

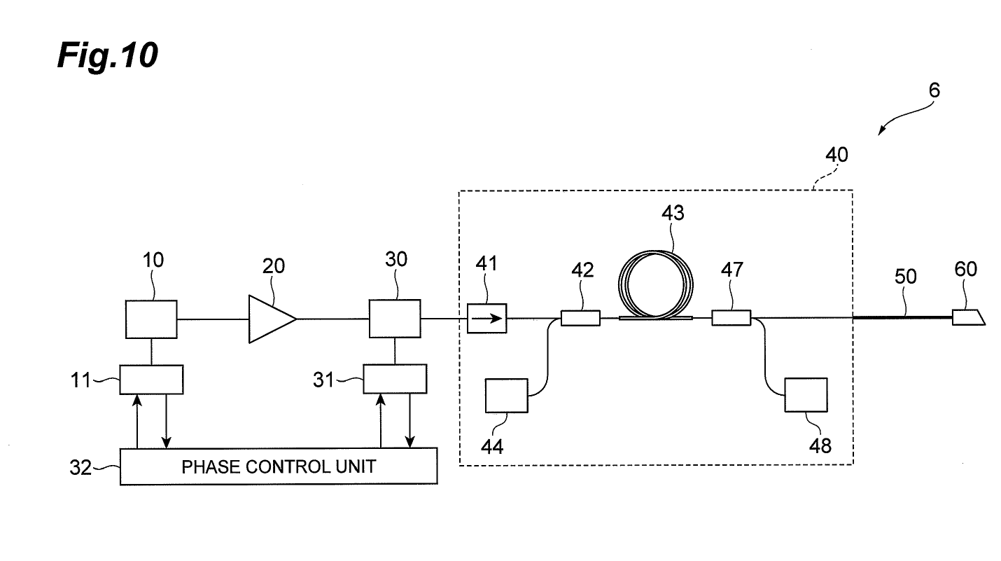

Moreover, while the foregoing embodiment explained a case of adopting the so-called co-propagating method in which the pumping light source 43 is provided to the final amplifier 40 of the laser apparatus 2 in a state that is before the amplification optical fiber 43, the configuration may also be a counter-propagating method, or, as shown in FIG. 10, the configuration may also be a co- and counter-propagating method in which the optical combiner 47 and the pumping light source 48 are also provided in a stage subsequent to the amplification optical fiber 43. Note that FIG. 10 is a view showing the schematic configuration of the laser apparatus 6 according to a fourth modified example of the present embodiment.

In accordance with the present invention, it is possible to provide a laser apparatus capable of easily achieving pulse-shortening. Consequently, not only can the pulse width be shortened, it is also possible to vary the pulse width with a simple apparatus. Moreover, since there is no need to control the intensity and the like of the pulsed light outputted from the seed light source, the intensity of light that is inputted to the intermediate amplifier and the final amplifier can be stabilized.

What is claimed is:

1. A laser apparatus, comprising:
a light source which outputs pulsed light during a predetermined output period;
an optical modulator which outputs the pulsed light inputted from the light source thereto during a predetermined modulation period;
a control unit which controls a pulse width of the pulsed light outputted from the optical modulator, by adjusting the output period of the light source and the modulation period of the optical modulator; and
a final amplifier which amplifies light outputted from the optical modulator.

2. The laser apparatus according to claim 1, further comprising an intermediate amplifier provided between the light source and the optical modulator,
wherein the intermediate amplifier amplifies the pulsed light outputted from the light source, and outputs the amplified pulsed light toward the optical modulator so that the amplified pulsed light is inputted to the optical modulator.

3. The laser apparatus according to claim 2, wherein the intermediate amplifier is configured from a plurality of amplifiers.

4. The laser apparatus according to claim 1, further comprising an intermediate amplifier provided between the optical modulator and the final amplifier,
wherein the intermediate amplifier amplifies the pulsed light outputted from the optical modulator, and outputs the amplified pulsed light toward the final amplifier so that the amplified pulsed light is inputted to the final amplifier.

5. The laser apparatus according to claim 1, wherein the control unit changes the pulse width of the pulsed light outputted from the optical modulator, by adjusting a period when the output period of the light source and the modulation period of the optical modulator overlap each other.

6. The laser apparatus according to claim 1, wherein the final amplifier includes an amplification optical fiber, and a pumping light source for supplying pumping light to the amplification optical fiber, and
wherein the laser light source includes a current control unit for controlling a current to be supplied to the pumping light source based on the pulse width of the pulsed light controlled by the control unit.

7. The laser apparatus according to claim 1, wherein the output period of the light source is set to be delayed from the modulation period in a state where a part of the output period of the light source overlaps the modulation period of the optical modulator.
